(19) United States
(12) Patent Application Publication
(10) Pub. No.: US 2025/0290356 A1
(43) Pub. Date: Sep. 18, 2025

(54) FRUNK LATCH ASSEMBLY WITH BI-DIRECTIONAL POWER LATCH RELEASE MECHANISM

(71) Applicant: MAGNA CLOSURES INC., Newmarket (CA)

(72) Inventor: Francesco CUMBO, Newmarket (CA)

(21) Appl. No.: 19/074,307

(22) Filed: Mar. 7, 2025

Related U.S. Application Data
(60) Provisional application No. 63/564,611, filed on Mar. 13, 2024.

(51) Int. Cl. E05B 81/24; B62D 25/12; E05B 81/04; E05B 81/14; E05B 81/18; E05B 81/30; E05B 83/24

(52) U.S. Cl. CPC E05B 81/25; E05B 81/04; E05B 81/14; E05B 81/18; E05B 81/30; E05B 83/243; B62D 25/12

(57) ABSTRACT

A closure latch assembly for a vehicle closure panel having a dual stage power release mechanism with a release lever configured for movement in a first direction and an opposite second direction. A first actuation of an actuator causes a first stage actuation, whereat the release lever is moved in the first direction to move closure latch assembly from a fully latched state to a partially latched state. A second actuation of the actuator causes a second stage actuation, whereat the release lever is moved in the second direction to move closure latch assembly from the partially latched state to an open state.

### CROSS-REFERENCE TO RELATED APPLICATIONS

This application claims the benefit of U.S. Provisional Application Ser. No. 63/564,611, filed Mar. 13, 2024, which is incorporated herein by reference in its entirety.

### FIELD

The present disclosure relates generally to closure latches for a vehicle closure member. More particularly, the present disclosure is directed to a hood/frunk latch equipped with a bi-directional release mechanism.

### BACKGROUND

This section provides background information related to closure latches and is not necessarily prior art to the closure latch of the present disclosure.

Many modern closure latches for closure panels, such as front hoods, trunks, and frunk (front trunks) of motor vehicles are power actuatable. Latches for vehicle hoods, whether for rear trunks, front engine hoods or front trunk hoods, are typically dual stage latched that are actuated in two separate stages, with such latches sometimes referred to as double pull-type latches. It is known to release a double pull-type latch via power actuation, wherein the power actuator must be actuated twice, in separate actuations, to move in opposite directions twice. Accordingly, a first stage actuation causes the power actuator to move in opposite directions from a home position to a release position and then back to the home position, whereupon the latch is moved from a primary latched state to a secondary latched state. Then, a separate second stage actuation causes the power actuator to move again in opposite directions from the home position to the release position and then back to the home position, whereupon the latch is moved from the secondary latched state to an unlatched state. Although such power actuated double pull-type latches are well suited for their intended use, they come with drawbacks. For example, the dual duty cycles required of the power actuator to release a double pull-type latch requires twice the duty cycle of a single pull-type latch, including a power reset actuation of the power actuator from the release position back to the home position in each separate actuation, and thus, the useful life of the power actuator of the power actuated, double pull-type latch is reduced, and can be cut in half or nearly in half. Accordingly, improvements are needed to address at least the aforementioned drawbacks.

### SUMMARY

This section provides a general summary of the disclosure and is not intended to be considered as a comprehensive and exhaustive listing of its full scope or all of its aspects, features and objectives.

It is an aspect of the present disclosure to provide a latch assembly for a closure member of a motor vehicle, the latch assembly having a latch mechanism, a power actuator, and a release lever in operable communication with the power actuator and with the latch mechanism. A first powered actuation of the power actuator drives the release lever from a home position to a deployed position to move the latch mechanism and actuate a first function of the latch assembly, and a second powered actuation of the power actuator drives the release lever from the deployed position to the home position to move the latch mechanism and actuate a second function of the latch assembly, with the second function being different from the first function.

It is an aspect of the present disclosure to provide a closure latch assembly for a vehicle closure panel, with the closure latch assembly having a dual stage power release mechanism. The closure latch assembly includes a latch mechanism, a power actuator, and a release lever in operable communication with the power actuator and with the latch mechanism. The release lever is moveable in a first direction from a home position to a deployed position, and in a second direction, opposite the first direction, from the deployed position to the home position. A first powered actuation of the power actuator drives the release lever in the first direction from the home position to the deployed position to move the latch mechanism and actuate a first function of the latch assembly. A second powered actuation of the power actuator drives the release lever in the second direction from the deployed position to the home position to move the latch mechanism and actuate a second function of the latch assembly, with the second function being different from the first function.

In accordance with another aspect, the latch mechanism includes a ratchet moveable between a striker capture position, whereat the ratchet captures a striker against release from the ratchet and a striker releasing position, whereat the ratchet releases the striker for removal from the ratchet, and a safety hook moveable between a safety hook striker capture position, whereat the safety hook captures the striker against removal from the latch assembly, and a safety hook striker releasing position, whereat the safety hook releases the striker for removal from the latch assembly, the first function including moving the ratchet from the striker capture position to the striker releasing position while leaving the safety hook in the safety hook striker capture position.

In accordance with another aspect, the second function includes moving the safety hook from the safety hook striker capture position to the safety hook striker releasing position.

In accordance with another aspect, the latch mechanism further includes a pawl moveable between a ratchet holding position and a ratchet releasing position and an actuator lever operably coupled to the pawl and to the safety hook. The actuator lever is arranged for engagement with the release lever while the release lever moves in the first direction to move the ratchet from the striker capture position to the striker releasing position, and while the release lever moves in the second direction, the release lever moves the safety hook from the safety hook striker capture position to the safety hook striker releasing position.

In accordance with another aspect, the actuation lever is biased to a home position by a biasing member. The actuator lever is moveable in a first direction against the bias of biasing member from the home position to a first deployed position by the release lever while the release lever moves in the first direction. The actuator lever is further moveable in a second direction, opposite the first direction, against the bias of biasing member from the home position to a second deployed position by the release lever in response to the release lever moving in the second direction.

In accordance with another aspect, the actuation lever is returned to its home position by the biasing member when the release lever is in its home position and when the release lever is in its deployed position.

In accordance with another aspect, the actuator lever is operably coupled to the pawl with a first cable and to the safety hook with a second cable.

In accordance with another aspect, the latch mechanism further includes a pawl release lever configured to move the pawl from the ratchet holding position to the ratchet releasing position while the release lever moves in the first direction, wherein the first cable is attached to the pawl release lever.

In accordance with another aspect, the first cable is in tension and the second cable has slack while the release lever moves in the first direction, and the second cable is in tension and the first cable has slack while the release lever moves in the second direction.

In accordance with another aspect, the power actuator is configured to drive the release lever in the first direction when energized by a first polarity signal, and to drive the release lever in the second direction when energized by a second polarity signal, wherein the first polarity signal has an opposite polarity to the second polarity signal.

It is a further aspect of the present disclosure to provide a closure latch assembly for a vehicle closure panel including a power actuator and a release lever in operable communication with the actuator, wherein the release lever is moveable, in response to a first activation of the power actuator, in a first direction from a primary position to a secondary position and, in response to a second activation of the power actuator, the release lever is moveable in a second direction, opposite the first direction, from the secondary position to the primary position. Further, a pawl is moveable between a ratchet holding position and a ratchet releasing position, and a primary ratchet is moveable between a primary striker capture position, whereat the pawl is in the ratchet holding position and a striker is captured by the primary ratchet to retain the closure member in a primary closed position, and a striker releasing position, whereat the pawl is in the ratchet releasing position and the striker is free to be removed from the primary ratchet. Further, a secondary ratchet is moveable between a secondary striker capture position, whereat the striker is captured by the secondary ratchet to retain the closure member in a secondary closed position while the primary ratchet is in the striker release position, and a secondary ratchet striker releasing position, whereat the striker is free to be removed from the secondary ratchet and the closure member is free to be moved to an open position. A first powered actuation of the power actuator drives the release lever in the first direction from the primary position to the secondary position, whereat the pawl is moved from the ratchet holding position to the ratchet releasing position and the primary ratchet is moved from the striker capture position to the striker releasing position. A second powered actuation of the power actuator, after having performed the first powered actuation, drives the release lever in the second direction from the secondary position to the primary position, whereat the secondary ratchet is moved from the striker capture position to the secondary ratchet striker releasing position.

It is a further aspect of the present disclosure to provide a method of arranging a power actuated latch assembly for movement between a primary latched state, whereat a closure member is maintained in a fully closed position, a secondary latched state, whereat the closure member is maintained in a partially closed position, and an open state, whereat the closure member can be moved to a fully open position. The method includes, providing the power actuated latch assembly having a latch mechanism including a primary ratchet and a secondary ratchet, with the primary ratchet having a primary striker capture position, whereat the primary ratchet captures a striker fixed to the closure member, and a primary striker releasing position, whereat the primary ratchet releases the striker, and with the secondary ratchet having a secondary striker capture position, whereat the secondary ratchet captures the striker against release, and a secondary striker releasing position, whereat the secondary ratchet releases the striker. Further, providing the power actuated latch assembly having a power actuator, and providing the power actuated latch assembly having a release lever arranged in operable communication with the power actuator and with the latch mechanism, with the release lever being moveable in a first direction from a home position to a deployed position, and in a second direction, opposite the first direction, from the deployed position to the home position. Further yet, arranging the power actuator such that a first powered actuation of the power actuator drives the release lever in the first direction from the home position to the deployed position to move the primary ratchet from the primary striker capture position to the primary striker releasing position, while maintaining the secondary ratchet in the secondary ratchet striker capture position. Further, arranging the power actuator such that a second powered actuation of the power actuator drives the release lever in the second direction from the deployed position to the home position to move the secondary ratchet from the secondary striker capture position to the secondary striker releasing position.

In accordance with a further aspect, the method can further include arranging an actuator lever in operably coupled relation with the pawl and with the secondary ratchet, and arranging the actuator lever for engagement with the release lever while the release lever moves in the first direction to move the primary ratchet from the striker capture position to the striker releasing position, and arranging the actuator lever for engagement with the release lever while the release lever moves in the second direction to move the secondary ratchet from the secondary ratchet striker capture position to the secondary ratchet striker releasing position.

In accordance with a further aspect, the method can further include operably coupling the actuator lever to the pawl with a first cable, and operably coupling the actuator lever to the secondary ratchet with a second cable.

Further areas of applicability will become apparent from the description provided herein. As noted, the description and any specific examples in this summary are intended for purposes of illustration only and are not intended to limit the scope of the present disclosure.

### BRIEF DESCRIPTION OF THE DRAWINGS

The drawings described herein have been provided to illustrate selected embodiments and specific features thereof and are not intended to limit the scope of the present disclosure. The present disclosure will now be described by way of example only with reference to the attached drawings, in which:

FIG. 1 is a perspective view of motor vehicle having a power actuated double pull latch assembly including a bi-directional power release mechanism in accordance with one aspect of the disclosure;

FIG. 2A is a side view of the bi-directional power release mechanism of the power actuated double pull latch assembly constructed in accordance with a non-limiting aspect of the disclosure shown in a deactivated state with the power actuated double pull latch assembly shown in a primary latched position;

FIG. 2B is a view similar to FIG. 2A illustrating the bi-directional power release mechanism in a first activated state with the power actuated double pull latch assembly moved to a secondary latched position;

FIG. 2C is a view similar to FIG. 2A illustrating the bi-directional power release mechanism in a second activated state with the power actuated double pull latch assembly moved to an unlatched position;

FIG. 3 is a diagram illustrating a power duty cycle of an actuator moving the bi-directional power release mechanism of the power actuated double pull latch assembly from a primary latched state to a secondary latched state, and then from the secondary latched state to an open state; and

FIG. 4 is a flow diagram illustrating a method of causing a power actuated double pull latch assembly constructed in accordance with the disclosure to move from a primary latched state to a secondary latched state, and then from the secondary latched state to an unlatched state.

### DETAILED DESCRIPTION OF EXAMPLE EMBODIMENTS

Example embodiments of a closure latch for use in motor vehicle door closure systems are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

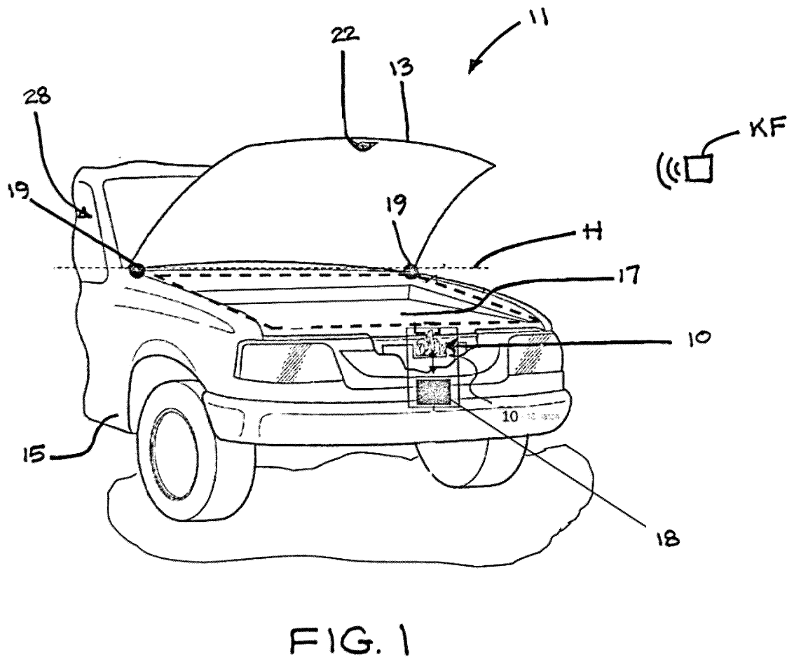

Reference is made to FIG. 1, which shows a motor vehicle 11 that has a closure member, shown as a front hood 13, to which a striker 22 is fixedly attached. Front hood 13 may enclose an engine, in known fashion, or a front trunk 17, also referred to as frunk 17, for storage in a compartment provided in the front of the vehicle 11 where an engine typically would occupy but has been provided at another location in the vehicle. The striker 22 is capturable by a power actuatable double pull closure panel latch assembly, also referred to as a power actuated double pull hood latch assembly if used in a vehicle hood application, and is generally referred to hereafter simply as power actuated double pull latch assembly or latch assembly 10, which is mounted on a body 15 of the motor vehicle 11. It is to be understood that the power actuation can be commanded via any internal button or feature within a cabin 28 of motor vehicle 11, and/or within front trunk 17, and/or via an external feature, including a button, lever, handle, or key fob KF, by way of example and without limitation.

The front hood 13, as permitted by powered actuation of latch assembly 10, can be moved from the fully closed position, also referred to as primary closed position, to various open positions, whereat hood 13 is pivoted between the fully closed and various open positions about a hinge axis H defined by hinges 19. The various open positions include a partially open position, also referred to as secondary open position, whereat the front hood 13 is prevented from being fully opened absent further actuation of latch assembly 10, and a fully open position, whereat striker 22 can be removed from latch assembly 10 and front hood 13 can be lifted to the fully open position (FIG. 1) to provide full access to the stowage space, or frunk 17.

The latch assembly 10 is shown, by way of example and without limitation, as having a latch mechanism 31 including a variety of interacting components, including, a primary ratchet, also referred to as ratchet 30, pivotably connected to a housing 20. Ratchet 30 is movable between a primary striker capture position, also referred to as primary closed position or closed position, and a primary striker release position, also referred to as striker release or striker releasing position or open position. Ratchet 30 is biased by a primary ratchet biasing member 30a toward the open position. Ratchet 30 has a slot S, as is known, for locking receipt of striker 22 therein while in the closed position.

Latch mechanism of ratchet assembly 12 is further shown, by way of example and without limitation, as having a secondary ratchet, also referred to as safety catch or safety hook 32, pivotably connected to the housing 20. Safety hook 32 is movable between a secondary striker capture position, also referred to as secondary closed position, and a safety hook striker release position, also referred to as release position. Safety hook 32 is biased by a secondary ratchet biasing member, also referred to as safety hook biasing member 32a, toward the secondary striker capture position.

Ratchet 30 is moveable in response to selective movement of a pawl 34. Pawl 34 is moveable between a primary ratchet holding position, also referred to as ratchet holding position, and a primary ratchet releasing position, also referred to as ratchet releasing position, as an example of a first latch function. Ratchet 30 is configured for movement between the primary striker capture position, whereat the pawl 34 is in the ratchet holding position and the striker 22 is captured by the ratchet 30 to retain the closure member 13 in the primary closed position, and the striker releasing position, upon the pawl 34 moving to the ratchet releasing position, whereat the striker 22 is free to be removed from the ratchet 30.

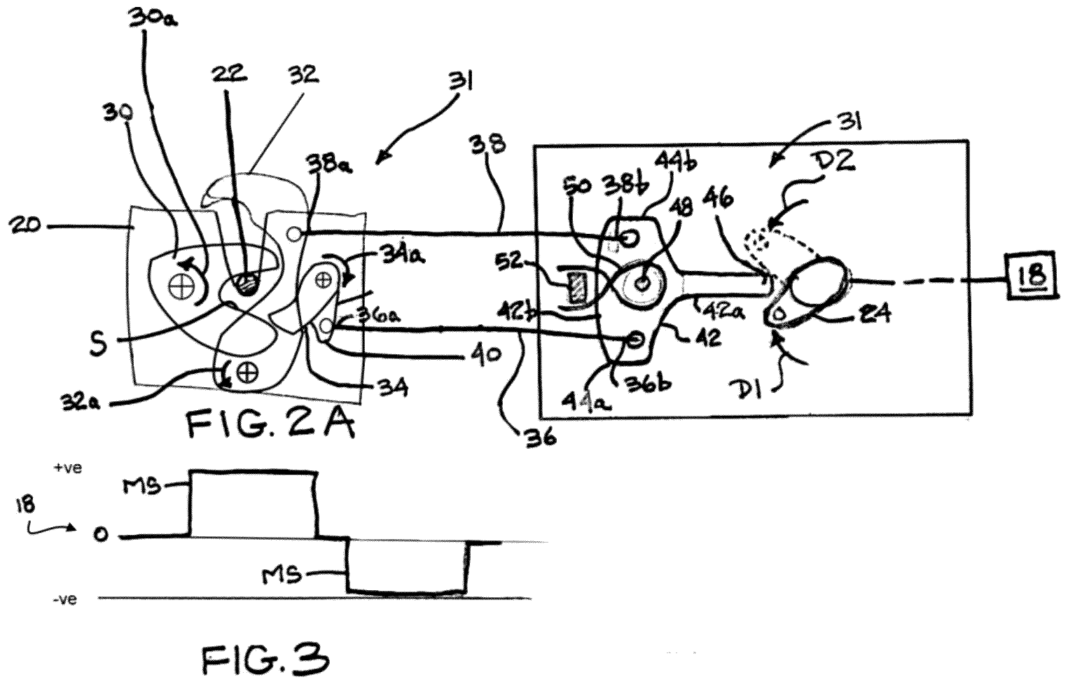

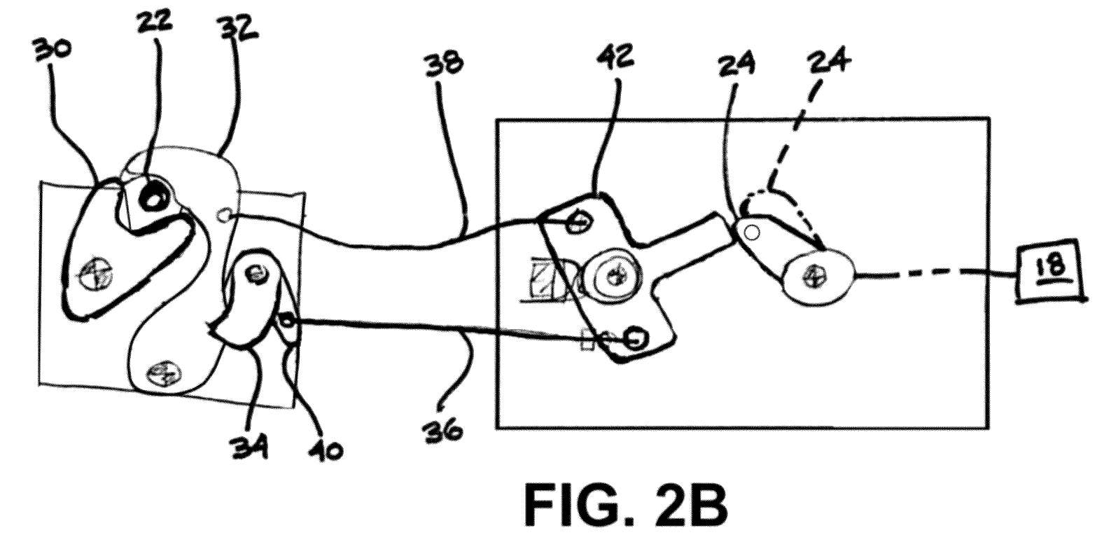

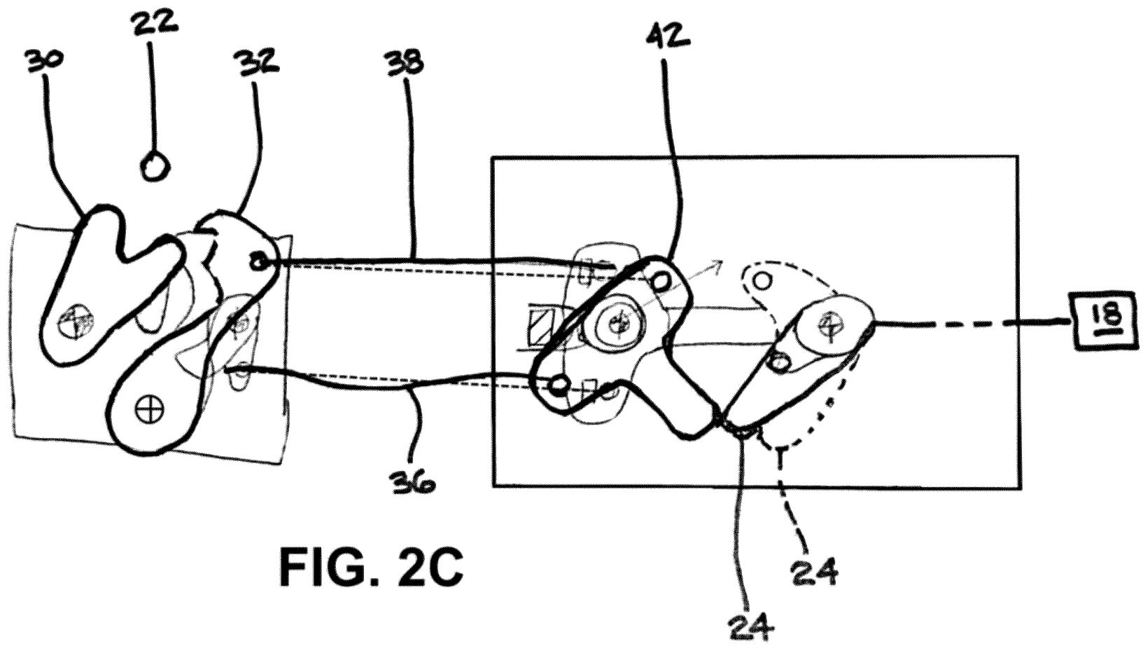

Latch assembly 10 is power actuatable, and in accordance with the disclosure herein, latch assembly 10 is power actuatable as a double actuation type assembly, also referred to as a double pull latch assembly. Thus, movement of the latch assembly 10 from the primary, fully latched position or state to the unlatched, open position or state requires two actuations, also referred to as two activations, of a power actuator 18. A first of the two actuations, referred to hereafter as a first actuation of power actuator 18, results in a first latch function via operable communication between a release lever 24 and pawl 34, with release lever 24 being configured in operable communication with power actuator 18. Then, a second of the two actuations, referred to hereafter as a second actuation of power actuator 18, results in a second latch function via operable communication between the release lever 24 and safety hook 32. During the first actuation of power actuator 18, power actuator 18 drives the release lever 24 in a first direction D1 (FIG. 2A) from a home position, also referred to as primary position, to a deployed position, also referred to as secondary position, whereupon the pawl 34 is moved from the ratchet holding position to the ratchet releasing position and the ratchet 30 is moved from the striker capture position to the striker releasing position, thereby performing the first latch function, which results in the latch assembly 10 being moved from a primary latched state, whereat closure member 13 is in the fully closed position, to a secondary latched state, also referred to as partially latched state, whereat closure member 13 is in the partially closed position. With ratchet 30 in the striker releasing position, and prior to the second actuation of actuator 18, safety hook 32 remains in the secondary striker capture position, thereby capturing striker 22 and holding front hood 13 in the partially closed position. While front hood 13 is in the partially closed position, air is able to enter the frunk 17 while the motor vehicle 11 remains drivable without visual obstruction to a driver by the front hood 13. Then, during the second actuation of power actuator 18, power actuator 18 drives release lever 24 in a second direction D2 (FIG. 2B), opposite the first direction D1, from the deployed or secondary position back to the home or primary position, whereat the safety hook 32 is moved, via operable communication with release lever 24, from the secondary striker capture position to the safety hook striker releasing position, thereby allowing striker 22 to be released from latch assembly 10, and thus, performing the second latch function, whereat front hood 13 can be moved to the fully open position. Power actuator 18 can affect the dual direction driving of release lever 24 via reversing polarity of a motor signal (MS) from a positive signal to a negative signal, by way of example and without limitation, as shown in FIG. 3.

In accordance with a non-limiting embodiment, release lever 24 is operably coupled to pawl 34 via a first linkage, wherein first linkage can be provided via a first cable 36, by way of example and without limitation, and release lever 24 is operably coupled to safety hook 32 via a second linkage, wherein second linkage can be provided via a second cable 38, by way of example and without limitation. First cable 36 can be connected directly to pawl 34, or operably connected to pawl 34 via a pawl release lever 40, with pawl release lever 40 being configured to drive pawl 34 from its ratchet holding position to the ratchet releasing position during the first actuation. Second cable 38 can be connected directly to safety hook 32, as shown, or operably connected to safety hook 32 via an intermediate linkage, as desired.

The first cable 36 is attached to the pawl release lever 40 via a first end 36a of first cable 36 and to an actuator lever 42 via a second end 36b of first cable 36. The second cable 38 is attached to the safety hook 32 via a first end 38a of second cable 38 and to the actuator lever 42 via a second end 38b of second cable 38.

Actuator lever 42 is shown as being generally T-shaped, having a driven leg portion 42a and a drive arm portion 42b, with the drive arm portion 42b extending between opposite ends 44a, 44b and with driven leg portion 42 extending from an approximate mid-region between the opposite ends 44a, 44b to a terminal free end 46. As such, driven leg portion 42a corresponds a vertical leg of the T-shape of actuator lever 42 and drive arm portion 42b corresponds to a top cross portion of the T-shape of actuator lever 42.

Second end 36b of first cable 36 is attached to one end 44a of driven arm portion 42b and second end 38b of second cable 38 is attached to the opposite end 44b of drive arm portion 42b. Accordingly, actuator lever 42 is operably coupled to pawl 34, the pawl release lever 40, and the safety hook 32 via first and second cables 36a, 36b. Driven leg portion 42a is arranged to be driven via engagement with release lever 24. In particular, as discussed above, as release lever 24 is rotated via power actuator 18 from its home position to its deployed position in the first direction D1, release lever 24 engages free end 46 of driven leg portion 42a, thereby driving actuator lever 42 rotatably about a pivot axis 48, shown, by way of example and without limitation, as being centrally located between the first and second ends 44a, 44b of drive arm portion 42b. As actuator lever 42 is driven about pivot axis 48, actuator lever 42 overcomes a bias imparted by a biasing member, shown as a torsion spring 50 wound about pivot axis 48. Biasing member 50, which is stabilized and restrained by a fixed spring mount feature 52, releasably holds actuator lever 42 in a home position (FIG. 2A), whereat first and second cables 36, 38 are generally free from tension, thereby allowing pawl 34 and safety hook 32 to remain in their locations under respective biases imparted by pawl biasing member 34a and safety hook biasing member 32a.

During the first actuation of power actuator 18, actuator lever 42 is driven rotatably in a first direction, shown as counterclockwise about pivot axis 48 as viewed in FIG. 2B, by release lever 24 against the bias imparted by biasing member 50 from its home position to a first deployed position, whereat actuation lever 42 is at or close to a location of tangency with an end of release lever 24 (FIG. 2B), whereupon first cable 36 is pulled and placed under tension by actuator lever 42, thereby pulling pawl release lever 40 and moving pawl 34 to its ratchet releasing position. Upon pawl 34 being pivoted to its ratchet releasing position, ratchet 30 moves under the bias of ratchet biasing member 30a to its striker releasing position, whereupon striker 22 is captured by safety hook 32, placing the latch assembly 10 in its partially open position. Upon actuator lever 42 reaching its deployed position, release lever 24 continues to be driven by power actuator 18 to its fully deployed position, as shown in dashed line, beyond tangency with actuator lever 42 and out from engagement with actuator lever 42, thereby allowing actuator lever 42 to return to its home position (FIG. 2A) under the bias imparted by biasing member 50 while release lever 24 is in its fully deployed position. After the release lever 24 has been moved to the deployed position from the home position following the first powered actuation, the power actuator 18 is disabled for example by ceasing the flow of current to the power actuator 18 such that the release lever 24 can remain in the deployed position.

After the power actuator 18 is disabled, the release lever 24 in the deployed position is not returned to the home position until the second powered actuation. In other words, before the second powered actuation, the release lever 24 is not returned from the deployed position to the home position by a spring force e.g. bias force such as a return spring, nor is the release lever 24 is returned from the deployed position to the home position by the power actuator 18 driving the actuator lever 42. The return of the release lever 24 from the deployed position to the home position results from two separate power actuations, which may for example be separated by a cessation of power flow to the power actuator 18. Each separate power actuation may be a single powered actuation, followed by a cessation of power to the powered actuator 18, that causes a single latch function. As a result, a return spring is not needed to be employed to reposition the release lever 24 first into a home position before the second powered actuation occurs. Also as a result, a separated dedicated power actuation to perform a reset of the release lever 24 to the home position where no latch function is actuated is not required, thereby reducing the number of cycles of the power actuator during each latch release function to improve reliability and longevity of the powered actuator.

During the second actuation of power actuator 18, actuator lever 42 is driven rotatably in a second direction, opposite the first direction, shown as clockwise about pivot axis 48 as viewed in FIG. 2C, by release lever 24 about pivot axis 48 against the bias of biasing member 50 from its home position to a second deployed position, whereat actuation lever 42 is at or close to a location of tangency with an end of release lever 24 (FIG. 2C), whereupon second cable 38 is pulled and placed under tension by actuator lever 42, thereby pulling safety hook 32 to its safety hook striker releasing position. Upon safety hook 32 being moved to its safety hook striker releasing position, striker 22 is released from captured engagement by safety hook 32, thereby allowing striker 22 to be removed from latch assembly 10 and thus, placing the latch assembly 10 in its fully open position. Upon actuator lever 42 reaching its deployed position release lever 24 is continues to be driven by power actuator 18 to its home position, as shown in dashed line, beyond tangency with actuator lever 42 and out from engagement with actuator lever 42, thereby allowing actuator lever 42 to return to its home position (FIG. 2A) under the bias imparted by biasing member 50 while release lever 24 remains in its home position.

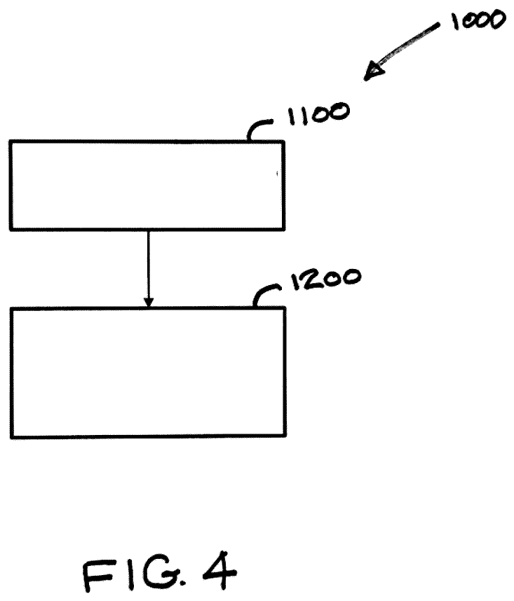

In accordance with a further aspect of the disclosure, as generally illustrated in FIG. 4, a method 1000 of fully releasing latch assembly 10 from a latched state, to a secondary latched state, and then to a fully unlatched state is provided. The method 1000 can be performed via a first actuation 1100 of power actuator 18 via a first polarity (+ve) signal MS1 to drive release lever 24 in the first direction D1, thereby moving latch assembly 10 from the latched state to the secondary latched state. Then, a second actuation 1200 of power actuator 18 can be performed, via a reversal of first polarity to a second polarity (−ve) signal MS2, to drive release lever 24 in the second direction D2, thereby moving latch assembly 10 from the secondary latched state to the unlatched state. It is to be recognized that the first actuation of power actuator 18 causes power actuator 18 to be driven from a home position in a first direction to a secondary actuated position, corresponding to the secondary latched position of latch assembly 10, and that the second actuation of power actuator 18 causes power actuator 18 to be driven from the secondary actuated position in a second direction, opposite the first direction, back to the home positon, corresponding to the unlatched position of latch assembly 10. Accordingly, the power actuator 18 only needs to be driven once in the first direction and once in the second direction to cause latch assembly 10 to be moved from the primary latched state to the unlatched state, thereby minimizing the duty cycle of the power actuator 18, and thus, prolonging the useful life of actuator 18, while also minimizing the potential for noise generation.

The method 1000 can further include arranging an actuator lever 42 in operably coupled relation with the pawl 34 and with the secondary ratchet 32, and arranging the actuator lever 42 for engagement with the release lever 24 while the release lever 24 moves in the first direction to move the primary ratchet 30 from the striker capture position to the striker releasing position, and arranging the actuator lever 42 for engagement with the release lever 24 while the release lever 24 moves in the second direction to move the secondary ratchet 32 from the secondary ratchet striker capture position to the secondary ratchet striker releasing position.

The method 1000 can further include operably coupling the actuator lever 42 to the pawl 34 with a first cable 36, and operably coupling the actuator lever 42 to the secondary ratchet 32 with a second cable 38.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A latch assembly for a closure member of a motor vehicle, the latch assembly comprising:
a latch mechanism;
a power actuator; and
a release lever in operable communication with the power actuator and with the latch mechanism;
wherein a first powered actuation of the power actuator drives the release lever from a home position to a deployed position to move the latch mechanism and actuate a first function of the latch assembly,
wherein a second powered actuation of the power actuator drives the release lever from the deployed position to the home position to move the latch mechanism and actuate a second function of the latch assembly, with the second function being different from the first function.

2. The latch assembly of claim 1, wherein after the release lever is moved to the deployed position by the first powered actuation the power actuator is disabled and the release lever remains in the deployed position.

3. The latch assembly of claim 2, wherein after the power actuator is disabled, the release lever in the deployed position is not returned to the home position until the second powered actuation.

4. The latch assembly of claim 3, wherein after the power actuator is disabled, the release lever in the deployed position is not returned to the home position by a spring force.

5. The latch assembly of claim 1, wherein the release lever is moveable in a first direction from the home position to the deployed position, and in a second direction, opposite the first direction, from the deployed position to the home position;
wherein a first powered actuation of the power actuator drives the release lever in the first direction from the home position to the deployed position to move the latch mechanism and actuate a first function of the latch assembly,
wherein a second powered actuation of the power actuator drives the release lever in the second direction from the deployed position to the home position to move the latch mechanism and actuate a second function of the latch assembly, with the second function being different from the first function.

6. The latch assembly of claim 5, wherein the latch mechanism includes a ratchet moveable between a striker capture position, whereat the ratchet captures a striker against release from the ratchet and a striker releasing position, whereat the ratchet releases the striker for removal from the ratchet, and a safety hook moveable between a safety hook striker capture position, whereat the safety hook captures the striker against removal from the latch assembly, and a safety hook striker releasing position, whereat the safety hook releases the striker for removal from the latch assembly, the first function including moving the ratchet from the striker capture position to the striker releasing position while leaving the safety hook in the safety hook striker capture position.

7. The latch assembly of claim 6, wherein the second function includes moving the safety hook from the safety hook striker capture position to the safety hook striker releasing position.

8. The latch assembly of claim 7, further including a pawl moveable between a ratchet holding position and a ratchet releasing position, wherein the latch mechanism includes an actuator lever operably coupled to the pawl and to the safety hook, the actuator lever being arranged for engagement with the release lever while the release lever moves in the first direction to move the ratchet from the striker capture position to the striker releasing position and while the release lever moves in the second direction to move the safety hook from the safety hook striker capture position to the safety hook striker releasing position.

9. The latch assembly of claim 8, wherein the actuator lever is biased to a home position by a biasing member, the actuator lever being moved in a first direction against the bias of biasing member from the home position to a first deployed position by the release lever while the release lever moves in the first direction, and the actuator lever being moved in a second direction, opposite the first direction, against the bias of biasing member from the home position to a second deployed position by the release lever while the release lever moves in the second direction.

10. The latch assembly of claim 9, wherein the actuator lever is returned to its home position by the biasing member when the release lever is in its home position and when the release lever is in its deployed position.

11. The latch assembly of claim 8, wherein the actuator lever is operably coupled to the pawl with a first cable and to the safety hook with a second cable.

12. The latch assembly of claim 11, further including a pawl release lever configured to move the pawl from the ratchet holding position to the ratchet releasing position while the release lever moves in the first direction, the first cable being attached to the pawl release lever.

13. The latch assembly of claim 11, wherein the first cable is in tension and the second cable has slack while the release lever moves in the first direction, and the second cable is in tension and the first cable has slack while the release lever moves in the second direction.

14. The latch assembly of claim 1, wherein the power actuator is configured to drive the release lever in a first direction when energized by a first polarity signal and to drive the release lever in a second direction when energized by a second polarity signal, wherein the first polarity signal has an opposite polarity to the second polarity signal.

15. The latch assembly of claim 14,
wherein after the release lever is moved to the deployed position the power actuator is disabled and the release lever remains in the deployed position;
wherein the release lever in the deployed position is not returned to the home position until the power actuator is energized by the second polarity signal.

16. A power actuated latch assembly for a closure member of a motor vehicle, comprising:
a power actuator;
a release lever in operable communication with the actuator, the release lever being moveable, in response to a first activation of the power actuator, in a first direction from a primary position to a secondary position and, in response to a second activation of the power actuator, being moveable in a second direction, opposite the first direction, from the secondary position to the primary position;
a pawl moveable between a ratchet holding position and a ratchet releasing position;
a primary ratchet moveable between a primary striker capture position, whereat the pawl is in the ratchet holding position and a striker is captured by the primary ratchet to retain the closure member in a primary closed position, and a striker releasing position, whereat the pawl is in the ratchet releasing position and the striker is free to be removed from the primary ratchet; and
a secondary ratchet moveable between a secondary striker capture position, whereat the striker is captured by the secondary ratchet to retain the closure member in a secondary closed position while the primary ratchet is in the striker release position, and a secondary ratchet striker releasing position, whereat the striker is free to be removed from the secondary ratchet and the closure member is free to be moved to an open position,
wherein a first powered actuation of the power actuator drives the release lever in the first direction from the primary position to the secondary position, whereat the pawl is moved from the ratchet holding position to the ratchet releasing position and the primary ratchet is moved from the striker capture position to the striker releasing position,
wherein a second powered actuation of the power actuator drives the release lever in the second direction from the secondary position to the primary position, whereat the secondary ratchet is moved from the striker capture position to the secondary ratchet striker releasing position.

17. The power actuated latch assembly of claim 16, further including an actuator lever operably coupled to the pawl and to the secondary ratchet, the actuator lever being arranged for engagement with the release lever while the release lever moves in the first direction to move the primary ratchet from the striker capture position to the striker releasing position and while the release lever moves in the second direction to move the secondary ratchet from the secondary ratchet striker capture position to the secondary ratchet striker releasing position.

18. The power actuated latch assembly of claim 17, wherein the actuation lever is biased to a home position by a biasing member, the actuator lever being moved in a first direction against the bias of biasing member from the home position to a first deployed position by the release lever while the release lever moves in the first direction, and the actuator lever being moved in a second direction, opposite the first direction, against the bias of biasing member from the home position to a second deployed position by the release lever while the release lever moves in the second direction, wherein the actuation lever is returned to its home position by the biasing member when the release lever is in its home position and when the release lever is in its deployed position.

19. The power actuated latch assembly of claim 17, wherein the actuator lever is operably coupled to the pawl with a first cable and to the secondary ratchet with a second cable.

20. The power actuated latch assembly of claim 19, further including a pawl release lever configured to move the pawl from the ratchet holding position to the ratchet releasing position while the release lever moves in the first direction, the first cable being attached to the pawl release lever.
